(19) United States
(12) Patent Application Publication
(10) Pub. No.: US 2012/0180944 A1
(43) Pub. Date: Jul. 19, 2012

(54) METHODS FOR MANUFACTURING PANELS AND PANEL OBTAINED HEREBY

(75) Inventor: Guy Van Hooydonck, Schoten (BE)

(73) Assignee: FLOORING INDUSTRIES LIMITED, SARL, Bertrange (LU)

(21) Appl. No.: 13/499,470

(22) PCT Filed: Sep. 13, 2010
(86) PCT No.: PCT/IB2010/054115

§ 371 Date: Mar. 30, 2012

(30) Foreign Application Priority Data
Oct. 1, 2009 (BE) BE2009/0601

(51) Int. Cl. B32B 33/00

(52) U.S. Cl. 156/222

(57) ABSTRACT

A method for manufacturing panels, which, at least at one side, include a motif, which is formed by a print, and a relief, may involve matching the print to the relief.

### BACKGROUND

1. Field

This invention relates to a method for manufacturing panels, as well as to panels which can be obtained by such methods.

More particularly, the invention relates to methods for manufacturing panels which show at least at one side a motif formed by a print.

The panels of the invention may be, for example, of the type which comprises at least a substrate and a top layer provided on this substrate, wherein said top layer comprises the aforementioned motif, which is formed by a print, and a transparent or translucent synthetic material layer. Herein, this may relate, for example, to furniture panels, ceiling panels, floor panels or the like, which substantially consist of an MDF or HDF (Medium or High Density Fiberboard) basic panel or substrate and a top layer provided thereon. In particular, this relates to a method wherein one or more material layers are provided on the substrate, wherein at least one of these material layers is provided by means of a print, which is performed directly on the substrate, wherein this print then forms at least a part of said motif.

2. Related Art

Such panels are known as such, for example, from U.S. Pat. No. 1,971,067 or DE 195 32 819 A1. From the aforementioned documents, it is also known that said material layers can comprise one or more primer layers, wherein these primer layers extend substantially below said print, and/or can comprise one or more finishing layers, which substantially extend above said print. Such finishing layers may comprise, for example, transparent or translucent synthetic material layers, which form a protective layer above the printed decor and can comprise, for example, wear-resistant particles, such as aluminum oxide. It is not excluded that this protective layer comprises a material sheet, such as a paper sheet.

The state of the art in connection with panels which are provided with a print performed directly on the substrate further becomes clear, amongst others, from WO 01/48333, U.S. Pat. No. 6,991,830, WO 02/00449, WO 2009/013580 and DE 10 2004 009 160 A1.

From the state of the art, also possibilities are known for forming a relief at the surface of such panels. For example, a relief can be realized by forming impressions in said synthetic material layer by means of a press element or by local application of chemicals, which dispel the material of the synthetic material layer, such as it is the case, for example, in U.S. Pat. No. 6,991,830. Further, from WO 2009/013580, techniques are known which allow obtaining a relief which corresponds to the motif. However, the techniques from the state of the art are not very flexible and, for example, do not allow that the conformity between motif and relief is influenced during manufacture.

### SUMMARY

The present invention in the first instance aims at offering an alternative method for manufacturing panels, which method, according to various preferred embodiments thereof, can be performed more smoothly and/or economical than the methods from the state of the art, and/or offers solutions for one or more of the disadvantages from the state of the art.

To this aim, the invention relates to a method for manufacturing panels, which, at least at one side, show a motif, which is formed by a print, and a relief, with the characteristic that the method comprises at least the step of matching said print to said relief. The invention allows that the relief can be kept unaltered, whereas the print can be adapted in order to obtain an increasingly better conformity between the motif and the relief. The panels of the invention can consist of larger boards, from which, by dividing them, floor panels, furniture panels, ceiling panels or the like are obtained, as well as of panels which already show approximately the dimensions of the final floor panels, furniture panels, ceiling panels or the like.

The method of the invention is very interesting, for example, when said relief is realized by means of a press element and the step of matching said print is performed at least when putting a new, revised and/or repaired press element to use and/or when exchanging or altering the press element. In such cases, the invention allows to respond to unexpected relief geometries. In such case, the aforementioned print can be adapted such that, for example, again an acceptable conformity between the motif and the relief is obtained. Said unexpected relief geometries may occur, for example, in the production or repair of the press element and/or by tolerances when exchanging the press element and/or by other known and/or unknown factors.

A specific example of such unexpected relief geometry can occur when, for example, a damaged structure portion is removed from a press element and is replaced in that a new and/or similar structure portion is adhered to this press element. For example, this new structure portion can be welded to the remainder of the press element. In such case, inaccuracies may occur in the position and/or orientation of the new structure portion in respect to the remaining structure portion. These inaccuracies lead to unexpected relief geometries, which can be noticed when manufacturing a first series of panels. The data relating to this unexpected relief geometry then can be applied, according to the invention, in the step of matching the print to the obtained relief. Possibly, in this manner conformity between relief and motif can be obtained in a following series of panels.

The invention is also very interesting when, for realizing the relief, use is made of composed press elements, and/or when use is made of at least two press elements, which are realized separately. Composed press elements and separately formed press elements are known as such from WO 2006/136949. In such cases, larger tolerances are expected for the global structure of the composition. It is of interest to be able to compensate possible deviations by adapting the print.

It is possible that the aforementioned step of adapting said print is no longer repeated after one or more adaptations performed when starting up manufacture. Such starting up may comprise, for example, putting a new, revised or repaired press element to use and/or exchanging the press element. Such possible embodiment of the method is of interest, for example, when the applied processes as such are stable once they have been started up. According to the present possibility, the method of the invention preferably comprises the further step that the panels, after one or more initial adaptations of the print, each time are provided with the same print and relief.

It is also possible that said step of adapting said print is repeated one or more times during the manufacture of the panels, or that during said manufacture it is checked at least one or more times whether such adaptation is useful or not. By means of such embodiment, the risk is minimized that the quality of the obtained panels is reduced during their manufacturing process. Such possible embodiment is interesting, for example, when various factors exert an influence or can exert an influence on the applied processes. Such factor may be, for example, a varying temperature. According to the present possibility, the method of the invention preferably comprises the further step that the manufactured panels, whether or not at fixed intervals, are inspected and that according to the findings, said print is adapted or not adapted to said relief.

In general, it is clear that by means of the method at least two panels can be manufactured having an identical relief, however, having a different print.

It is noted that there, where a conformity between the motif and the relief is mentioned, this conformity as such can be limited, however, also can be total. This may relate, for example, to conformity in direction, surface and/or position of certain motif portions with certain relief portions, wherein these respective portions can have any size. When the motif represents one or more tiles with cement grouts, such motif portion or relief portion may coincide, for example, with an actual tile portion, with the transition between two of such tiles, for example, with the cement grout, and/or with a characteristic feature of a respective tile portion. When the motif represents one or more wooden plank parts, such motif portion and/or relief portion can coincide, for example, with a wooden plank part, with the transition between two of such plank parts, and/or with a characteristic feature of a respective plank part, for example, with a wood pore, wood nerve or wood knot. Preferably, a so-called structure in register with the motif is striven for.

Further, it is noted that the invention can also be applied when it is striven for a relief portion which is in a fixed relation to a motif portion, however, does not necessarily coincide therewith.

According to a particular preferred embodiment of the present invention, the method further is characterized by the fact that said panels are of the type which comprises at least a substrate and a top layer provided on this substrate, wherein said top layer comprises said motif, which is formed by a print, and a transparent or translucent synthetic material layer. Herein, said relief preferably is provided in said synthetic material layer and this relief comprises recesses and/or protrusions, which correspond to the motif of the aforementioned print. In such case, the method preferably comprises at least the following steps:
the step of realizing digital basic data in connection with said motif;
the step of realizing a press element;
the step of performing said print on the basis of motif data derived from said digital basic data;
the step of applying said synthetic material layer; and
the step of realizing said relief by means of said press element.

By means of such method preferably at least a first series of panels and a second series of panels are manufactured. Said step of matching the print then preferably consists at least in that the relief and motif obtained with the first series of panels are compared to each other, wherein the possible difference in conformity here between is applied for realizing adapted motif data. Herein, these adapted motif data then preferably are applied for manufacturing said second series of panels, such that the possible difference in conformity between the relief and the motif in said second series of panels is smaller than it has been the case in said first series of panels.

The abovementioned particular preferred embodiment allows still realizing a relatively flexible method with a less flexible production means, such as structure foils or press platens, whereby a very good conformity between the motif and the relief can be achieved.

In general, the method of the invention will show its benefits best when said relief is realized by means of a press element. Preferably, the step of realizing the press element then comprises at least an etching treatment. Etching treatments as such are time-consuming and not very flexible. Preferably, said press element comprises a plate, roller or belt or consists thereof. The press element can also comprise a structure foil or consist thereof.

Preferably, prior to the step of realizing the relief, a relative alignment of the motif and the press element will take place. Such alignment preferably is performed on the basis of a perception of the position and/or orientation of said print. In this manner, deviations in the conformity between motif and relief already can be neutralized for the major part. According to the invention, the remaining part of the deviations then can be compensated by adapting the print or the motif data on which it is based.

The digital basic data, which are mentioned in said particular preferred embodiment, are obtained at least preferably by means of scanning or photographing archetypes, such as real wood parts, real stones or the like. Of course, it is not excluded that these scan or photo data are processed in order to arrive at the final digital basic data. Deriving the motif data from the digital basic data can comprise one or more treatments, such as a treatment in which the individual basic colors are separated from the digital basic data, and/or a treatment in which a part of the digital basic data is selected and/or a treatment in which a portion of the digital basic data is made sharper or more blurred.

Preferably, in the step of realizing the press element, use is made of structural data, which are also derived from said digital basic data. The derivation of the structural data from the digital basic data can comprise one or more treatments, such as a treatment wherein the depth and/or the position of structure portions of said digital basic data is separated and/or a treatment in which the aforementioned depth is being restricted.

It is noted that said derivation of motif data and/or structural data can also relate solely to adopting the digital basic data.

Preferably, for realizing said first series of panels as well as for realizing said second series of panels, the same press element is applied. When applying, however, another press element, then preferably a press element is applied which is realized on the basis of identical or similar structural data. In such case, the method most rapidly leads to conformity between motif and relief.

Preferably, said adapted motif data comprise at least an adaptation chosen from the series of scaling, rotating and translating at least a motif part, whereas preferably the remaining part of the motif data is left unaltered or almost unaltered. Of course, it is not excluded that the entire motif data undergo such transformation. Another possibility for forming adapted motif data concerns the displacement of marks to be printed. Such marks may be applied, for example, for aligning a possible press element in respect to the print.

It is clear that, in the case of the above-mentioned particular preferred embodiment and in the case that the aforementioned step of adapting said print is no longer repeated after one or more adaptations performed when starting up the manufacture, the method preferably further also comprises the step of applying the adapted motif data for manufacturing of a series of panels following the last adaptation, and preferably for each series of panels following the last adaptation.

It is also clear that in the case of the above particular preferred embodiment and in the case that said step of adapting said print is repeated one or more times during the manufacture of the panels or it is at least checked one or more times whether such adaptation is useful in view of the possibly found deviation, the method preferably further also comprises the step of applying the possibly further adapted motif data for manufacturing a series of panels following the last adaptation, and preferably for each series of panels following the last adaptation.

The present invention shows its advantages best when the aforementioned print is performed directly on the substrate, and still better when it is performed by means of one or more digital printing units, such as inkjet printers. By using a digital print directly performed on the substrate, the print can be adapted very smoothly to the relief. It is clear that use can be made of one or more primer layers, which extend below the print performed on the substrate. Such primer layer may provide, for example, in a sealing of the substrate and/or in a, whether or not neutral, printing background. Instead of performing the print directly on the substrate, it is, of course, possible that the print, preferably a digital print, is performed on a material sheet, such as a paper layer, which afterwards is adhered to the substrate.

The panels, which are obtained according to the invention, preferably comprise a substrate on the basis of a wood product, such as a substrate comprising MDF or HDF. The synthetic material layer may comprise, for example, a UV- or electron beam-cured lacquer layer. Preferably, the transparent or translucent synthetic material layer comprises additives, which enhance the wear-resistance of the panel, such as, for example, aluminum oxide particles. Preferably, the transparent or translucent synthetic material layer is made free from material sheets, such as paper layers. However, it is possible that the transparent or translucent synthetic material layer comprises cellulose fibers or other fibers.

It is clear that the invention also relates to panels which are obtained by means of a method with the characteristics of the present invention.

### BRIEF DESCRIPTION OF THE DRAWINGS

With the intention of better showing the characteristics of the invention, hereafter, as an example without any limitative character, some preferred embodiments are described, with reference to the accompanying drawings, wherein:

FIG. 1 schematically represents a method according to a non-limiting embodiment of the invention;

FIGS. 2 to 4 represents a view according to the directions F2, F3 and F4, respectively, shown in FIG. 1; and

FIGS. 5 to 6, in views respectively similar to those of FIGS. 3 and 4, represent a non-limiting embodiment of a panel which can be obtained by means of the method from FIG. 1.

### DESCRIPTION OF NON-LIMITING EMBODIMENTS

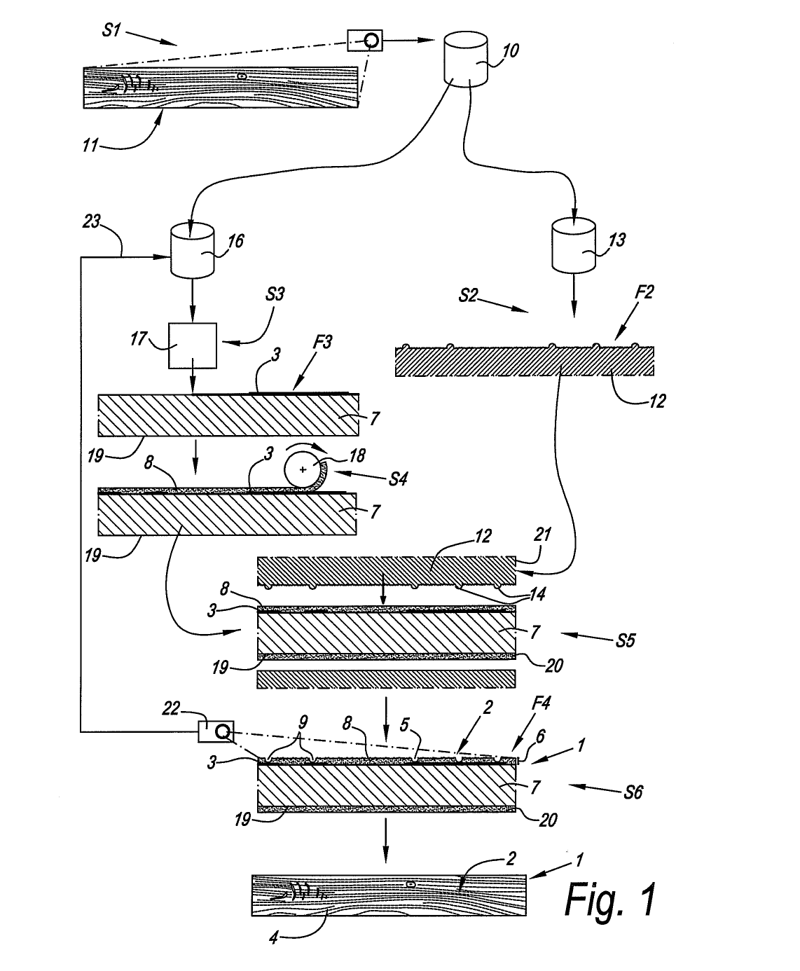

FIG. 1 represents a method for manufacturing panels 1, which comprise at least at one side, more particularly the decor side 2, a motif 4, which is formed by a print 3, and a relief 5.

In this case, the obtained panel 1, comprises, at the side 2 concerned, a top layer 6 which is provided on a substrate 7 or basic panel. Herein, said top layer 6 comprises said motif 4, which is formed by a print 3, and a transparent synthetic material layer 8. The relief 5 comprises recesses 9, which correspond to the aforementioned motif 4.

The method of FIG. 1 shows the characteristics of the particular preferred embodiment mentioned in the introduction. To this aim, FIG. 1 schematically represents some steps S1-S6 in such method.

In a first step S1, basic data 10 are collected in connection with the motif. These basic data 10 are digital and, in the example, are obtained by photographing an archetype 11, in this case a real wooden plank. Instead of or in combination with photographing, for example, also a scanning operation can be applied. Possibly, the archetype 11 can be treated, such that the basic data 10 can be taken up more smoothly and/or precisely. For example, possibly present wood pores can be accentuated with a colorant. Preferably, said basic data 10 are stored on a physical carrier, such as on a harddisk, USB memory, CD or DVD.

FIG. 1 represents that in a second step S2, a press element 12 is realized. In this case, for this purpose use is made of structural data 13, which are derived from said basic data 10. For the derivation, use can be made, for example, of algorithms, which filter data in connection with the depth of the structure from said digital basic data 10, and/or of algorithms which cut off the obtained depth data when said depths exceed a maximum, previously determined depth. Preferably, for this derivation use is made of one or more electronic processors and relevant software. Preferably, said structural data 13 are stored on a physical carrier, such as on a harddisk, USB memory, CD or DVD. Preferably, for organizing these structural data 13, the so-called .stl format is applied, or a similar digital format. Preferably, the digital character of the structural data 13 consists at least in that the structured surface, at least for a part thereof and preferably entirely, is approached by a series of flat objects, preferably triangles, wherein, still better, the coordinates of the corner points of these objects as well as the direction of the normal on these objects is stored.

The press element 12 represented here relates to a substantially flat metal press plate. For the step S2 of realizing the press element 12 as such, use can be made of one or more etching treatments and/or one or more mechanical treatments by means of a machining tool, such as a rotating milling tool. Preferably, said treatments herein are digitally controlled. In the case of a mechanical treatment, a computer-controlled machining treatment can be provided, such as a computer-controlled milling treatment. In the case of an etching treatment, for example, the mask and/or the etching means can be provided on the press plate by means of a computer-controlled head. For example, the techniques known as such from WO 2006/066776 can be applied.

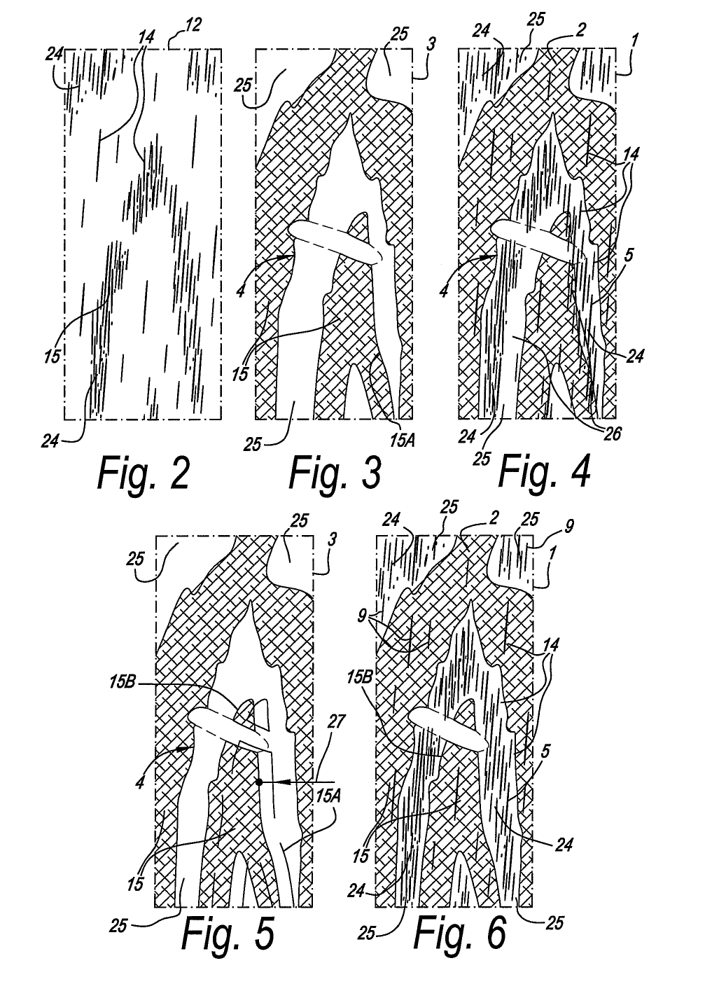

FIG. 2 represents a view on part of the structure of the obtained press element 12. Herein, this relates to a press element 12, which is equipped with the structure of wood. This structure in this case comprises at least wood pores 14, which substantially are concentrated along so-called flower structures 15.

FIG. 1 further also represents a third step S3. In this third step S3, said print 3 is performed. This print 3 uses motif data 16, which are derived from said basic data 10. Such derivation can comprise, for example, a color separation and/or can be performed by means of one or more electronic processors and pertaining software. Said derivation may comprise, for example, the selection of a motif part. For example, a motif part having approximately the size of the decor side 2 of the final panel 1 can be selected from motif data 16 in connection with a larger surface. Preferably, said motif data 16 are stored on a physical carrier, such as on a harddisk, USB memory, CD or DVD. Preferably, said motif data 16, in a separate manner, comprise data relating to the presence of at least three different colors in the motif, preferably at least three different basic colors, such as cyan, magenta and yellow. Additionally, the motif data 16, in a separate manner, can comprise data on the presence of black in the motif. Preferably, said motif data 16 is free from depth data also mentioned above. By “in a separate manner”, it is meant that the data concerned already are separately available, for example, in a separate data file, and thus do no longer have to be extracted from the whole of the aforementioned motif data 16.

FIG. 1 represents a possibility, wherein said motif data 16 or a part thereof are applied directly for controlling a printing device 17. In this case, an inkjet printhead is represented schematically. Preferably, such printing device 17 comprises at least three and preferably at least four inkjet printheads, which deposit ink of a different color on the substrate 7. Each of these inkjet printheads then can be controlled by another part of said motif data 16, namely, by those data which relate to the presence of the respective color in the motif 4. As aforementioned, such data can be obtained by separation.

It is noted that the aforementioned substrate 7, prior to the step S3 of printing, can be provided with one or more material layers and/or can be subjected to one or more sanding treatments. Such material layers, for example, can improve the adherence of the printing liquids, for example, of the inks, and/or provide a neutral background color for the print 3.

According to the invention, the substrate preferably consists substantially of a wood-based product, such as MDF or HDF (Medium or High Density Fiberboard).

In general, it is noted that the resolution of the digital basic data 10 preferably is larger than or equal to the resolution of the motif data 16 and/or the structural data 13. By the resolution of such data, the number of points per surface area, of which information or data are available, is meant. Preferably, the resolution of the motif data 16 is larger than or equal to the resolution of the structural data 13, and/or for realizing the print 3 a printing device 17 is applied having a precision which is higher than or equal to the precision which can be achieved when realizing the press element 12. In such cases, the present invention fully shows its advantages.

FIG. 1 represents that in a separate fourth step S4, the print 3 can be provided with said transparent or translucent synthetic material layer 8. In this case, the respective synthetic material layer 8 is applied in liquid form in one or several passes, for example, by means of one or more rollers 18. Preferably, said synthetic material layer 8 also comprises additives, which enhance the wear resistance of the finally obtained panel 1. As represented, the panel 1 can also be provided with a synthetic material layer 20 on the other side or underside 19. This synthetic material layer 20 can be applied, for example, for making the underside 19 of the panel 1 vapor-proof. The synthetic material layer 20 at the underside 19 of the panel 1 may or may not be realized pigmented.

FIG. 3 represents a view on a portion of the obtained print 3. It is clear that in this case, a print 3 with a wood motif 4 is concerned. In this case, it relates to a wood motif 4 comprising so-called flower patterns 15.

In a fifth step S5, represented in FIG. 1, the separately performed print 3 and the press element 12 meet. Hereby, said relief 5 is obtained. In the represented example, the press element 12 and the substrate 7, which is provided with the print 3 and synthetic material layer 8, are brought into a, whether or not heated, press device 21, in this case a short-cycle press (in German: Kurztaktpresse), wherein the structure of the press element 12 is applied for realizing said recesses 9 in the decor side 2 of the panel 1. Possibly, by means of the same press device 21 a curing of said synthetic material layer 8 can be obtained.

FIG. 1 further represents that the obtained relief 5 and motif 4 are compared to each other in a step S6. In this case, for performing the comparison, a camera 22 or other optical sensor is represented schematically. Other techniques than photographic techniques are of course not excluded. A possible difference in conformity between the relief 5 and motif 4 is applied for realizing adapted motif data 16. This is represented schematically by means of the arrow 23.

FIG. 4 represents a view on the conformity between the motif 4 and the relief 5 in the case of the print 3 from FIG. 3 and the press element 12 from FIG. 2. The desired conformity relates to a conformity between the colors of the print 3 and the zones 24 in which the wood pores 14 of the structure are concentrated. In this case, the zones 24 in which the wood pores 14 are concentrated have to correspond to the zones 25 of lighter color. As FIG. 4 represents, the conformity leaves much to be desired, in particular in the area 26.

With this determination, the motif data 16 are adapted, more particularly, as represented by arrow 27 in FIG. 5, a displacement is performed of the initial flower pattern 15A towards a new flower pattern 15B, which better corresponds to the relief 5 to be provided. When manufacturing a following series of panels 1, said adapted motif data 16 then can be applied in said step S3 of printing, such that the possible difference in conformity between the relief 5 and the motif 4 in this new series of panels 1 is smaller than it has been the case in the panels 1 manufactured beforehand.

FIG. 6 shows the result of the new print 3, on basis of the adapted motif data 16, and the relief provided by the, in this case held constant, press element 12. It is clear that, when in this case a difference in conformity between the relief 5 and the motif 4 should occur, this difference surely is smaller than the difference from FIG. 4. Further, it is clear that the method of the invention thus comprises at least the step of matching the print 3 to the relief 5.

It is clear that the panels 1 from FIGS. 4 and 6 form an example of panels 1 which are obtained by means of the same method, however, wherein in the meantime the motif data 16 have been adapted. Namely, the panels 1 from these figures show an identical relief 5, but a different print 3.

It is noted that the invention also relates to a device which can be applied when performing the method of the present invention or the preferred embodiments thereof. In particular, this relates to a device which comprises means 22 for taking up and/or detecting a possible difference in uniformity between the motif 4 and the relief 5. Preferably, for this purpose, such device comprises at least an optical sensor 22, such as a camera, which can inspect at least a portion of the respective side 2. Preferably, such device comprises at least means, such as an electronic processor and pertaining software, which is able to detect the possible difference in conformity on the basis of the taken up data. Still better, such device comprises means, such as such processor and software, which are able to adapt said print and/or motif data in an automatic or semi-automatic manner.

It is clear that the step S2 of realizing the press element 12 does not at all have to take place at the same location and/or at the same time as the printing. According to the invention, namely use can be made of an external supplier of press elements 12, who then manufactures, for example, the respective press elements 12 on the basis of the digital basic data 10 and/or the structural data 13 derived therefrom. In such cases, the method of the invention offers a logistic advantage. Namely, small defects of delivered press elements can be balanced by adapting the motif data, such that transporting the press element back to the supplier is unnecessary.

The present invention is in no way restricted to the embodiments described herein above; on the contrary may such methods and panels be realized according to various variants, without leaving the scope of the present invention.

1. A method for manufacturing panels, which, at least at one side, includes a motif, which is formed by a print, and a relief, the method comprising:
matching the print to the relief.

2. The method of claim 1, wherein the matching is performed at least when putting a new press element to use or when putting a revised or repaired press element to use.

3. The method of claim 1, wherein the matching, after one or more adaptations performed when starting up manufacture, is no longer repeated.

4. The method of claim 1, wherein the matching is repeated one or more times.

5. The method of claim 1, wherein by means of the method at least two panels are manufactured with identical reliefs, and with different prints.

6. The method of claim 1, wherein the panels are of the type which include at least a substrate and a top layer provided on the substrate, the top layer including the motif which is formed by the print, and a transparent or translucent synthetic material layer, the relief being provided in the synthetic material layer and the relief including recesses or protrusions, which correspond to the motif of the print, the method comprising:
realizing digital basic data in connection with the motif;
realizing a press element;
performing the print on the basis of motif data derived from the digital basic data;
applying the synthetic material layer; and
realizing the relief by means of the press element;
wherein the method is employed to manufacture at least a first series of panels and a second series of panels;
wherein the matching involves
comparing the relief to the motif obtained in the first series of panels to determine a possible difference in conformity,
applying the possible difference in conformity to realize adapted motif data, and
applying the adapted motif data for manufacturing the second series of panels, such that a possible difference in conformity between the relief and the motif in the second series of panels is smaller than the possible difference in conformity in the first series of panels.

7. The method of claim 6, wherein realizing the press element involves using structural data, which are derived from the digital basic data.

8. The method of claim 6, wherein for realizing the first series of panels and the second series of panels, the same press element is applied.

9. The method of claim 6, wherein the adapted motif data includes at least an adaptation chosen from the list of scaling, rotating and translating a motif part.

10. The method of claim 6, wherein the digital basic data are obtained at least partially by means of scanning or photographing of archetypes.

11. The method of claim 6, wherein the print is performed directly on the substrate.

12. The method of claim 11, wherein the print is performed by means of one or more digital printing units.

13. The method of claim 1, wherein the relief is realized by means of a press element; and
wherein realizing the press element involves at least an etching treatment.

14. The method of claim 13, wherein the press element includes a plate, roll or belt.

15. The method of claim 13, wherein the press element includes a structure.
